(19) United States
(12) Patent Application Publication
(10) Pub. No.: US 2016/0167665 A1
(43) Pub. Date: Jun. 16, 2016

(54) METHOD AND APPARATUS FOR CONTROLLING DUAL CLUTCH TRANSMISSION

(71) Applicant: HYUNDAI AUTRON CO., LTD., Seongnam-si (KR)

(72) Inventor: Seong-Jin PARK, Anyang-si (KR)

(21) Appl. No.: 14/961,310

(22) Filed: Dec. 7, 2015

(30) Foreign Application Priority Data
Dec. 15, 2014 (KR) 10-2014-0180288

(51) Int. Cl. B60W 30/19; B60W 10/113; B60W 10/02

(52) U.S. Cl. CPC B60W 30/19; B60W 10/02; B60W 10/113; B60W 2510/0241; B60W 2510/0657; B60W 2510/1005; B60W 2510/1015; B60W 2710/021; B60W 2710/027; B60W 2710/025; B60W 2710/1005

(57) ABSTRACT

The present invention relates to a method and apparatus for controlling a dual clutch transmission. The method includes receiving a gear shift start command; coupling a target gear to a second input shaft according to the gear shift start command; and releasing a first clutch torque applied to a first clutch associated with a first input shaft and increasing a second clutch torque applied to a second clutch associated with the second input shaft up to an engines torque, wherein the second clutch torque is determined by applying a target slip factor to a predetermined control position of the second clutch. According to the present invention, when a dual clutch transmission performs gear shift to a target gear, gear shift may m be quickly performed without obstruction by applying an optimum torque for controlling the clutch.

### CROSS REFERENCE TO RELATED APPLICATION

This application claims the benefit of Korean Patent Application No. 10-2014-0180288,filed on Dec. 15, 2014, entitled “METHOD AND APPARATUS FOR CONTROLLING DUAL CLUTCH TRANSMISSION”, which is hereby incorporated by reference in its entirety into this application.

### BACKGROUND

1. Technical Field

The present invention relates to a method and apparatus for controlling a dual clutch transmission.

2. Description of the Related Art

A dual clutch transmission (DCT), which is an automated manual transmission, includes two clutches. The DCT selectively transfers power input from the engine to one of the two input shafts and outputs power by adjusting the gear ratio of the gears disposed on the two input shafts.

More specifically, the DCT includes two input shafts and one output shaft. The engine is connected to one of the two input shafts by the clutch. The input shaft connected to the engine is connected to the output shaft by a gear, thereby transferring the power to the wheels. Of the two input shafts, a first input shaft is connected with gears of odd-numbered gear steps (gear steps 1, 3, 5 and 7), and a first clutch connects the gears of the odd-numbered gear steps to the engine. In addition, a second input shaft is connected to a gear for reverse drive R and gears of even-numbered gear steps (gear steps 2, 4 and 6), and a second clutch connects the gear for reverse drive and the gears of even-numbered gear steps to the engine.

According to this structure, when the vehicle is traveling with the first input shaft and the gears of the odd-numbered steps connected to the output shaft, shift to the gears of the even-numbered steps is performed by coupling the gears of the even-numbered steps on the second input shaft, releasing a first clutch torque applied to the first clutch, namely, the off-going clutch and increasing a second clutch torque applied to the second clutch, namely, the on-going clutch up to the engine torque.

Meanwhile, in the case of a dry clutch transmission, a motor is mainly used to increase torque applied to the clutch. That is, the displacement S of the motor is increased and converted into clutch torque. As the displacement of the motor increases, the clutch disc is pushed and torque T applied to the clutch disc is determined by multiplying the produced force by a coefficient of friction. The correlation between the displacement S of the motor and the torque T may be expressed with a T-S curve. In the transmission, the torque T according to a target motor displacement S may be determined based on the T-S curve.

In the conventional art, when gear shift is performed by the DCT, target torques of the offer-going clutch and the on-going clutch are adjusted based on the engine torque, the engine speed, the degree of opening of the throttle, the clutch temperature and the like. However, as the number gear steps increases, it is difficult to accurately adjust the target torques using conventional methods.

### SUMMARY

It is an object of the present invention to provide a method and apparatus for controlling a dual clutch transmission capable of quickly performing gear shift without obstruction by applying an optimum torque for controlling the clutch when the dual clutch transmission performs gear shift to a target gear.

It should be noted that objects of the present invention are not limited to the aforementioned object, and other objects of the present invention will be apparent to those skilled in the art from the following descriptions. The objectives and advantages of the invention may be realized and attained by elements recited in the claims and a combination thereof.

In accordance with one aspect of the present invention, a method for controlling a dual clutch transmission includes receiving a gear shift start command; coupling a target gear to a second input shaft according to the gear shift start command; and releasing a first clutch torque applied to a first clutch associated with a first input shaft and increasing a second clutch torque applied to a second clutch associated with the second input shaft up to an engines torque, wherein the second clutch torque is determined by applying a target slip factor to a predetermined control position of the second clutch.

In accordance with another aspect of the present invention, an apparatus for controlling a deal clutch transmission includes a controller configured to receive a gear shift start command, couple a target gear to a second input shaft according to the gear shift start command, and release a first clutch torque applied to a first clutch associated with a first input shaft and increase a second clutch torque applied to a second clutch associated with the second input shaft up to an engines torque, wherein the second clutch torque is determined by applying a target slip factor to a predetermined control position of the second clutch.

According to the present invention described above, when a dual clutch transmission performs gear shift to a target gear, gear shift may be quickly performed without obstruction by applying an optimum torque for controlling the clutch.

### BRIEF DESCRIPTION OF THE DRAWINGS

FIG. 1 is a block diagram illustrating an apparatus for controlling a dual clutch transmission (DCT) according to an embodiment of the present invention.

FIG. 2 illustrates a process of shifting gears of a vehicle from gear step 3 to gear step 4 by an apparatus for controlling a DCT according to an embodiment of the present invention.

FIG. 3 is a flowchart illustrating a method for controlling a DCT according to an embodiment of the present invention.

### DETAILED DESCRIPTION

The aforementioned advantages, objects, and features of the invention will be set forth in detail with reference to the accompanying drawings such that those skilled in the art can easily practice the present invention. In describing the present invention, a detailed description of well-known technologies will be omitted if it is determined that such description can unnecessarily obscure the main points of the present invention. Hereinafter, embodiments of the present invention will be described in detail with reference to the accompanying drawings. Wherever possible, the same reference numbers will be used throughout the drawings to refer to the same or like parts. It should be understood that the present invention is not limited to the following embodiments, and that the embodiments are provided for illustrative purposes only. The scope of the invention should be defined only by the accompanying claims and equivalents thereof.

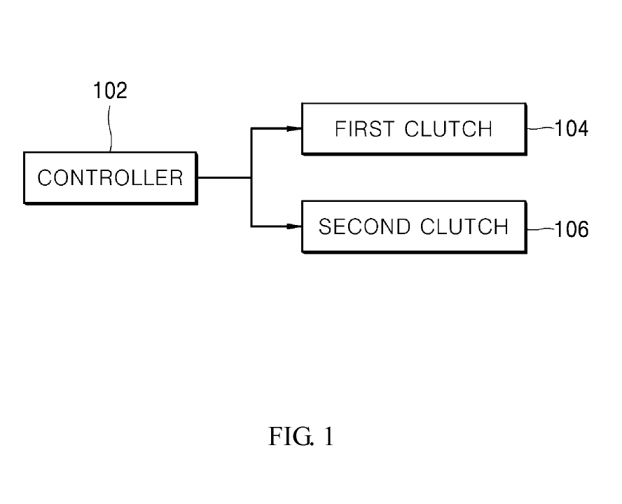

FIG. 1 is a block diagram illustrating an apparatus for controlling a dual clutch transmission (DCT) according to an embodiment of the present invention.

Referring to FIG. 1, an apparatus for controlling a DCT according to an embodiment of the present invention includes a controller 102. The controller 102 controls a first clutch 104 and a second clutch 106 according to a gear shift start command input by the driver and performs gear shift to a target gear. The first clutch 104 connects gears of odd-numbered gear steps (gear steps 1, 3, 5 and 7) of a first input shaft to the engine, and the second clutch 106 connects a reverse drive gear and gears of even-numbered gear steps (gear steps 2, 4 and 6) of a second input shaft to the engine. The controller 102 may connect the clutches 104 and 106 to the engine by applying torque to the clutches 104 and 106, and release connection between the clutches 104 and 106 and the engine by releasing the torque applied to the clutches 104 and 106. The present invention, obstruction or shock occurring during gear shift is minimized by determining the magnitude of optimum torque needed to connect the clutches 104 and 106 to the engine.

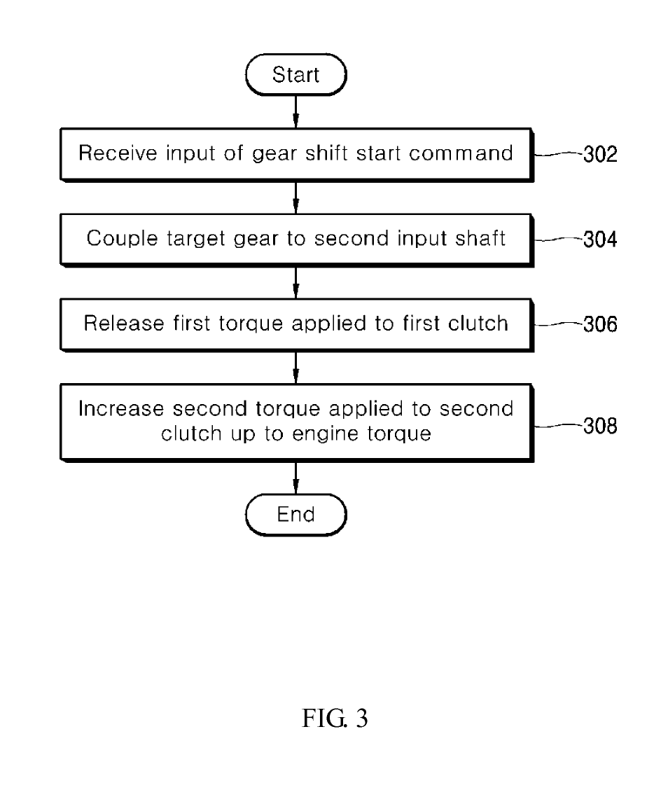

Hereinafter, a detailed description will be given of a method for controlling a DCT according to an embodiment of the present invention with reference to FIGS. 1 and 3, focusing on an exemplary process of a traveling vehicle performing gear shift from gear step 3 to gear step 4.

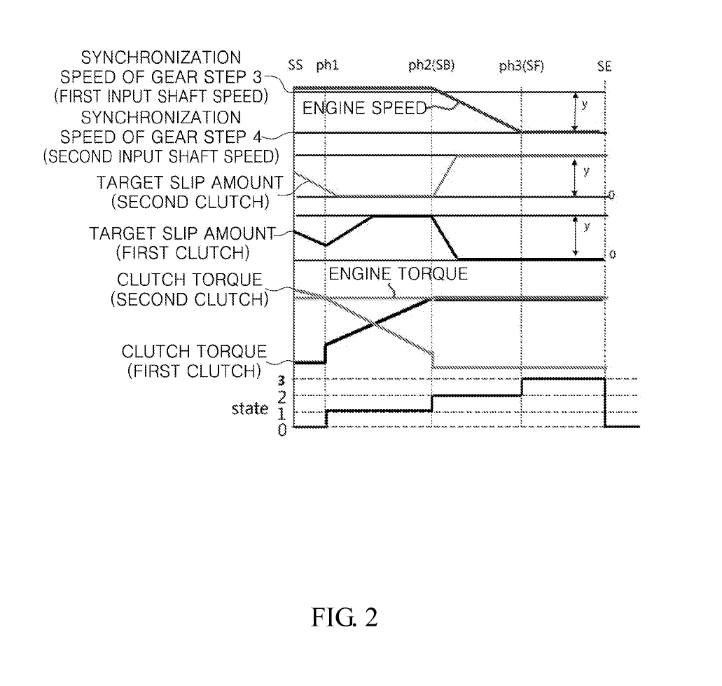

FIG. 2 illustrates a process of shifting gears from gear step 3 to gear step 4 in a vehicle by an apparatus for controlling a DCT according to an embodiment of the present invention.

In FIG. 2, the synchronization speed of gear step 3 represents the speed of the first input shaft obtained with the first input shaft coupled with the gear of gear step 3. In this case, when torque greater than or equal to the engine torque is applied to the first clutch 104, the engine speed is synchronized with the speed of the gear of gear step 3. In addition, the synchronization speed of the gear step 4 represents the speed of the second input shaft obtained with the second input shaft coupled with the gear of gear step 4. In this case, when torque greater than or equal to the engine torque is applied to the second clutch 106, the engine speed is synchronized with the speed of the gear of gear step 4. That is, the synchronization speed of gear step 4 refers to an expected speed of the engine obtained when the gear of gear step 4 is coupled to the second input shaft and torque greater than or equal to the engine torque is applied to the second clutch 106.

FIG. 2 illustrates a process of gear shift to the gear of gear step 4, which is a target gear, according to a gear shift start command issued by the driver during driving in gear step 3. The controller 102 changes the engine speed from the synchronization speed of gear step 3 to the synchronization speed of gear step 4 according to the gear shift start command by releasing the torque applied to the first clutch 104, namely, the off-going clutch and increasing the torque applied to the second clutch 106, namely, the on-going clutch.

In FIG. 2, SS denotes a point at which the gear shift start command is input. The gear of gear step 4 is coupled with the second input shaft at SS. In addition, ph1 is a point at which the torque applied to the clutch 104 is released and the torque applied to the second clutch 106 begins to increase after coupling of the gear of gear step 4. Symbol ph2 represents a point at which release of the torque applied to the first clutch 104 and increase of the torque applied to the second clutch 106 are completed, namely a torque transfer completion point. Symbol ph3 represents a point at which change of the engine speed to the synchronization speed of gear step 4 is completed after torque transfer. Finally, SE is a point at which gear shift is completed.

According to conventional art, gear shift smoothness of a DCT, namely shock from gear shift is determined by torque distribution to the first clutch 14 and the second clutch 16 in the torque transfer interval (between an ph1 and ph2) and the second clutch torque of the second clutch 106 at ph2. Accordingly, in conventional cases, the magnitude of the second clutch torque applied to the second clutch 106 is adjusted based on the engine torque, the vehicle speed, the engine speed, the change rate of the engine speed, temperature of the transmission, and the like to enhance smoothness of gear shift. In this process of determining the magnitude of the torque, calculation of the torque using a specific equation is not possible due to nonlinear characteristics of the vehicle. Accordingly, in the conventional cases, proper magnitudes of torque are randomly matched with respective gear shift types through repetitive tests based on theoretical data. However, with this method, a long research time is taken to determine magnitudes of torque proper for all gear shift types, and verification of the matching is not easy. In the present invention, a magnitude of torque to be applied to a clutch is more easily and accurately determined based on a target slip amount of the clutch.

Referring back to FIG. 2, at point ph2, torque (first clutch torque) of the first clutch 104, namely the off-going clutch is 0, and torque (second clutch torque) of the second clutch 106, namely the on-going clutch should be equal to the engine torque. At this time, if the second clutch torque of the second clutch 106 is greater than the engine torque, gear shift shock occurs in the torque transfer interval (between ph1 and ph2) due to interlocking, and the engine speed decreases to the synchronization speed of gear step 4. On the other hand, if the second clutch torque of the second clutch 106 is less than the engine torque, shock occurs due to interruption of torque and the engine speed increases.

According, to minimize gear shift shock, the engine torque at a point ph2 is preferably set to be equal to the second clutch torque applied to the second clutch 106. To this end, a target slip factor is applied to a control position of the second clutch 106 determined by a T-S curve. Herein, the target slip factor has a value determined based on a difference y between the synchronization speed of gear step 3 and the synchronization speed of gear step 4.

For example, when the engine torque is 100 NM, it is assumed that the second clutch 106 must move by 10 mm to obtain the second clutch torque equal to the engine torque. This assumption may be represented by torque 100-displacement 10 on the T-S curve. In other words, when the torque generated from the engine is 100 NM, moving the second clutch 106 by 10 mm synchronizes the engine speed with the speed of the second input shaft (synchronization speed of gear step 4). However, when it is assumed that the second clutch 106 needs to move by 7 mm to maintain the slip amount of 1000 rpm without synchronization between the engine and the second input shaft for the engine torque set to 100 NM, a target slip factor for the target slip amount of 1000 rpm is 0.7. Thereby, when the target slip factor of 0.7 is multiplied by the displacement 10 determined by the conventional T-S curve (torque 100-displacement 10), displacement of 7 mm for maintaining the slip amount of 1000 rpm may be obtained. In this case, the second clutch torque is 100 NM and thus smooth gear shift may be implemented.

FIG. 2 shows the target slip amount of the second clutch 106 for determining the target slip factor. The target slip amount of the second clutch 106 decreases linearly from point SS, at which gear shifting begins, to point ph1 , at which the gear of gear step 4 is coupled, namely in state 0. Thereafter, once the gear of gear step 4 is coupled at point ph1, the target slip amount increases linearly up to the synchronization speed difference y (state 1). The increment of the target slip amount, namely the rate of increase of the target slip amount may be changed according to a target slip value, namely, the synchronization speed difference y and a target gear step.

Thereafter, when the torque transfer is terminated (state 2), the target slip amount of the second clutch 106 decreases linearly again in order to synchronize the engine speed with the synchronization speed of gear step 4. Herein, the decrement of the target slip amount of the second clutch, namely the rate of decrease of the target slip amount may be changed according to a target slip value (e.g., 0) and a target gear step.

Accordingly, with the DCT of the present invention, the target slip amount of the on-going clutch (e.g., the second clutch 106) may be flexibly set according to the gear shift process as shown in FIG. 2, and a target slip factor calculated based on the set target slip amount may be applied to the control position of the off-going clutch. Thereby, optimum torque to be applied to the off-going clutch may be determined.

FIG. 3 is a flowchart illustrating a method for controlling a DCT according to an embodiment of the present invention.

Referring to FIG. 3, the controller 102 receives a gear shift start command input by the driver (302). Then, the controller 102 couples the second input shaft 106 with a target gear (e.g., the gear of gear step 4) (304), releases first clutch torque applied to the first clutch 104 (306). At the same time, the controller 102 increases second clutch torque applied to the second clutch 106 to the engine torque to perform gear shift (308).

Herein, the second clutch torque may be determined by applying a target slip factor to a predetermined control position of the second clutch 106. According to an embodiment of the present invention, the control position of the second clutch 106 may be determined by a T-S curve indicating torque applied to the second clutch 106 according to a displacement of the motor for moving the second clutch 106 and increase of the displacement of the motor. In addition, the target slip factor may be determined based on the target slip amount of the second clutch 106.

According to an embodiment of the present invention, the target slip amount may linearly increase from the time at which a gear is coupled with the second input shaft. In addition, the maximum value of the target slip amount may be set to be equal to the synchronization speed difference y between the first input shaft and the second input shaft. In addition, the target slip amount may linearly decrease from the time at which the second clutch torque applied to the second clutch 106 increases up to the engine torque.

Those skilled in the art will appreciate that various substitutions, modifications, variations can be made to the present invention without departing from the technical spirit of the invention and that the present invention is not limited to the embodiments described above and the accompanying drawings.

What is claimed is:

1. A method for controlling a dual clutch transmission, the method comprising:
receiving a gear shift start command;
coupling a target gear to a second input shaft according to the gear shift start command; and
releasing a first clutch torque applied to a first clutch associated with a first input shaft and increasing a second clutch torque applied to a second clutch associated with the second input shaft up to an engines torque,
wherein the second clutch torque is determined by applying a target slip factor to a predetermined control position of the second clutch.

2. The method according to claim 1, wherein the control position of the second clutch is determined by a T-S curve indicating torque applied to the second clutch according to a displacement of a motor for moving the second clutch and increase of the displacement of the motor.

3. The method according to claim 1, wherein the target slip factor is determined based on a target slip amount of the second clutch.

4. The method according to claim 3, wherein the target slip amount increases linearly from a time when the target gear is coupled to the second input shaft.

5. The method according to claim 3, wherein a maximum value of the target slip amount is equal to a difference in synchronization speed between the first input shaft and the second input shaft.

6. The method according to claim 3, wherein the target slip amount decreases linearly from a time when the second clutch torque applied to the second clutch increases up to the engine torque.

7. An apparatus for controlling a deal clutch transmission, the apparatus comprising:
a controller configured to receive a gear shift start command, couple a target gear to a second input shaft according to the gear shift start command, and release a first clutch torque applied to a first clutch associated with a first input shaft and increase a second clutch torque applied to a second clutch associated with the second input shaft up to an engines torque,
wherein the second clutch torque is determined by applying a target slip factor to a predetermined control position of the second clutch.

8. The apparatus according to claim 7, wherein the control position of the second clutch is determined by a T-S curve indicating torque applied to the second clutch according to a displacement of a motor for moving the second clutch and increase of the displacement of the motor.

9. The apparatus according to claim 7, wherein the target slip factor is determined based on a target slip amount of the second clutch.

10. The apparatus according to claim 9, wherein the target slip amount increases linearly from a time when the target gear is coupled to the second input shaft.

11. The apparatus according to claim 9, wherein a maximum value of the target slip amount is equal to a difference in synchronization speed between the first input shaft and the second input shaft.

12. The apparatus according to claim 9, wherein the target slip amount decreases linearly from a time when the second clutch torque applied to the second clutch increases up to the engine torque.
